(19) United States
(12) Patent Application Publication
(10) Pub. No.: US 2009/0206990 A1
(43) Pub. Date: Aug. 20, 2009

(54) AFTERMARKET CONVENIENCE ENTRY AND START SYSTEM

(75) Inventor: Robert NELSON, Hampstead (CA)

Correspondence Address: MERCHANT & GOULD PC, P.O. BOX 2903, MINNEAPOLIS, MN, 55402-0903, US

(73) Assignee: AUTOMOBILITY DISTRIBUTION INC., Ville St-Laurent (CA)

(21) Appl. No.: 12/369,588

(22) Filed: Feb. 11, 2009

Related U.S. Application Data
(60) Provisional application No. 61/064,007, filed on Feb. 11, 2008.

(51) Int. Cl. G08B 29/00; G06F 19/00

(52) U.S. Cl. 340/5.72; 701/113; 701/2

(57) ABSTRACT

A user detection system for a vehicle has a security system including a portable transponder, a touch sensor, a control system in communication with the touch sensor and the security system. A method installs the user detection system in the vehicle. The touch sensor includes a sensor strip installed on the exterior surface proximate the handle and a coating for covering the sensor strip, the coating visibly matching the exterior surface. The control system is operable to transmit the identification signal in response to receiving the sensor contact signal. The control system is operable to transmit the disable command to the security system upon authentication of the reply. An aftermarket push-to-start system includes a steering lock disabling device.

This application claims benefit of Ser. No. 61/064,007, filed 11 Feb. 2008 in the United States and which application is incorporated herein by reference. To the extent appropriate, a claim of priority is made the above disclosed application.

### FIELD OF THE INVENTION

The present invention relates to aftermarket systems for automotive vehicles. More particularly, and in its preferred intended use, the present invention relates to an aftermarket convenience entry and start system.

### BACKGROUND OF THE INVENTION

Security systems and the like are well known in the art, particularly those for motor vehicles.

Original equipment manufacturer (OEM) security systems, i.e. security systems that are installed in a vehicle by the vehicle manufacturer, can now include transponders mounted in keys, key fobs, cards, or other devices which communicate with an OEM security system in order to deter and prevent theft. These transponders are wireless data-carrying devices that automatically respond to an incoming radio frequency (RF) signal generated by the OEM security system by returning an identification code in order to authenticate the user's identity. The transponder is able to respond to the RF signal if it is within a given distance from the reader. These transponders serve to provide identification verification of a user to the OEM security system, which itself will keep the vehicle ignition in a disabled state until such verification has occurred.

In order to enhance user convenience, it is known to provide keyless entry systems which detect the presence of an authorized user and unlock the vehicle's doors automatically. Conventional OEM keyless entry systems typically include an OEM transponder contained in a portable identification device, such as a key fob or a key card, and an associated OEM reader which is operable to disarm the OEM security system and unlock a vehicle's doors upon detection of the OEM transponder.

In order to avoid the necessity of constantly sending out RF signals in order to detect the transponder, and thereby unnecessarily draining the vehicle's battery, a trigger mechanism is employed. Typically, a touch sensor is provided within the handle of the vehicle. When a user grasps the door handle, this contact is detected and the sensor is tripped. The security system then emits an RF signal and the transponder receives the signal and returns an identification signal. If this identification is successful, i.e. if the security system recognizes the transponder as that of an authorized user, the security system is disabled and the vehicle's doors are unlocked. This can typically be achieved in a short enough time that the user does not sense a lag between the touching of the door handle and the opening of the unlocked door.

In this manner, the security system need not continually send out RF signals in hopes of reaching a transponder, which would be a considerable waste of power since most users will only approach their respective vehicle a limited number of times on any given day.

In order to install such conventional door handle touch sensors, the interior of the door panel must be accessed. In an OEM setting, i.e. during assembly of a new vehicle, this can be accomplished without much difficulty by the original equipment manufacturer. However, such an installation is significantly more difficult, time consuming and expensive once the car is fully assembled. It would therefore be advantageous to provide a touch sensor for enabling an aftermarket keyless entry system which requires a less intrusive installation.

Further complicating matters is the fact that modern vehicle components are often manufactured of non-conductive materials, such as plastics and the like, or are coated in non-conductive materials. In such cases, it can be very difficult to incorporate a touch sensor on a vehicle's exterior. Many aftermarket keyless systems simply replace the non-conductive OEM handle.

As such, conventional aftermarket keyless entry systems are typically complex and expensive to install.

In order to enhance user convenience, it is also known to provide push-to-start systems which provide a push-button for vehicle starting. However, conventional OEM car ignition systems typically include a steering column locking mechanism which locks the steering wheel unless the vehicle's ignition key is received within the vehicle's ignition lock. It is also known for OEM car ignition systems to provide an electronic means of unlocking the steering column, for example by sending a databus code from the OEM security system to the steering column locking mechanism.

This poses a problem for aftermarket keyless starters such as aftermarket remote starters or aftermarket push-to-start systems.

Hence, in light of the aforementioned, there is a need for a device or a system which, by virtue of its design and components, would be able to overcome some of the aforementioned prior art problems.

### SUMMARY OF THE INVENTION

An aspect of the present invention is to provide an aftermarket convenience entry and start system which, by virtue of its design and components, satisfies some of the above-mentioned needs and is thus an improvement over other related devices and/or cleaning methods known in the prior art.

In accordance with a preferred embodiment of the present invention, there is provided a user detection system for a vehicle having a security system, an exterior surface and a handle installed into the exterior surface, the security system being responsive to a disable command, the user detection system including:
a) a portable transponder for verification of user;
b) a touch sensor for detecting contact made by the user and transmitting a sensor contact signal in response thereto, the touch sensor including:
   i) a sensor strip installed on the exterior surface proximate the handle; and
   ii) a coating for covering the sensor strip, the coating visibly matching the exterior surface;
c) a control system in communication with the touch sensor and the security system, the control system including:
   i) a reader for transmitting an identification signal to the portable transponder and receiving a corresponding reply; and
   ii) a microcontroller for authenticating the reply;
wherein the control system is operable to transmit the identification signal in response to receiving the sensor contact signal; and
wherein the control system is operable to transmit the disable command to the security system upon authentication of the reply.

Preferably, the microcontroller is mounted inside the vehicle and the control system further includes sensor circuitry connected to the touch sensor, the sensor circuitry being operable to wirelessly communicate with the microcontroller. Preferably, the sensor circuitry is installed along an inner portion of the vehicle's door.

In accordance with another embodiment of the present invention, there is provided a method of installing a user detection device for a vehicle including a security system, an exterior surface and a handle installed into the exterior surface, the security system being responsive to a disable command, the method including:
a) providing portable transponder for user verification;
b) fixing a sensor strip to the exterior surface proximate the handle;
c) covering the sensor strip with a coating, the sensor strip being operable to detect contact between the user and the coating and operable to transmit a sensor contact signal in response thereto;
d) providing a control system in communication with the sensor strip and the security system, the control system including:
   i) a reader for transmitting an identification signal to the transponder and receiving a corresponding reply; and
   ii) a microcontroller for authenticating the reply;
wherein the control system is operable to transmit the identification signal in response to receiving the sensor contact signal; and
wherein the control system is operable to transmit the disable command to the security system upon authentication of the reply.

In accordance with another embodiment of the present invention, there is provided an aftermarket push-to-start system for a vehicle including a driver compartment, a steering column lock responsive to a steering column lock disable command and an engine starter responsive to an engine start command, the system including:
a) a push-button installed within the driver compartment;
b) a controller operable to transmit the engine start command to the engine in response to engagement of the push-button by a user;
c) steering column lock disabling means operable to transmit the steering column lock disable command to the ignition lock in response to engagement of the push-button by the user; and
d) driver identification means for authenticating a user.

In accordance with another embodiment of the present invention, there is provided an aftermarket push-to-start system for a vehicle including a driver compartment, an ignition key, an ignition lock operable to receive the ignition key and an engine starter responsive to an engine start command, the system including:
a) a push-button installed within the driver compartment;
b) a controller operable to transmit the engine start command to the engine in response to engagement of the push-button by a user;
c) manual actuator fixed to the ignition lock and operable to retain the ignition key therein; and
d) driver identification means for authenticating a user.

Preferably, the driver identification means includes a portable transponder, a reader operable to transmit an identification signal to the transponder in response to engagement of the push-button by a user and receiving a reply, and a microcontroller for authenticating the reply, wherein the controller is operable to transmit the engine start command upon authentication of the reply by the microcontroller.

The invention and its advantages will be better understood by reading the following non-restrictive description of a preferred embodiment thereof, made with reference to the accompanying drawings.

### BRIEF DESCRIPTION OF THE DRAWINGS

The invention will be better understood upon reading the following non-restrictive description of the preferred embodiment thereof, made with reference to the accompanying drawings in which:

FIG. 1 is a schematic representation of a user diction system in accordance with an embodiment of the present invention.

FIG. 2 is a perspective view of a vehicle interior.

### DETAILED DESCRIPTION OF PREFERRED EMBODIMENTS OF THE INVENTION

In the following description, the same numerical references refer to similar elements. The embodiments shown in the figures are preferred, for exemplification purposes only.

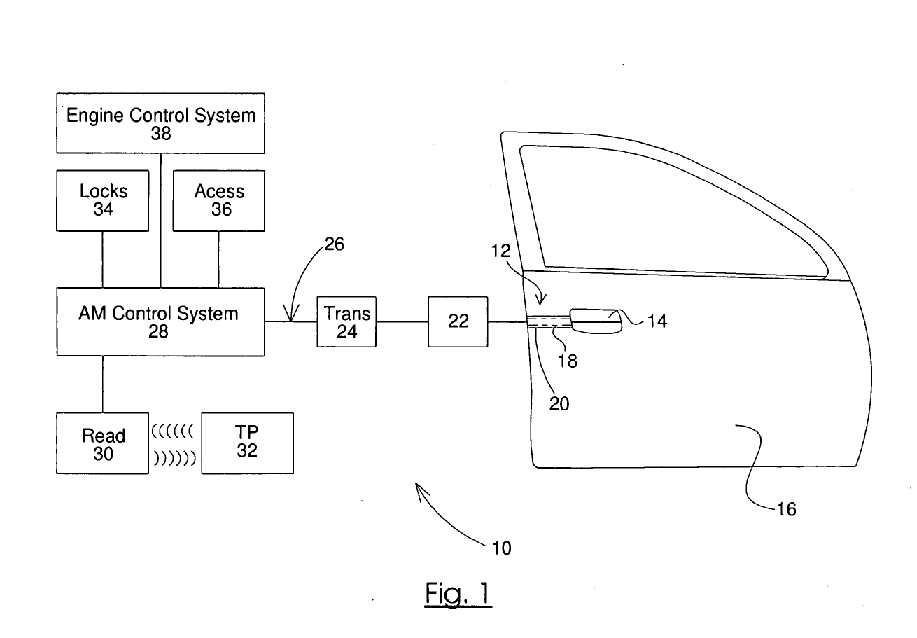

With reference to FIG. 1, a user detection system 10 includes an aftermarket touch sensor 12 mounted adjacent a handle 14 on a vehicle door 16. The touch sensor 12 includes a sensor strip 18 which is fixed to the exterior surface of the door 16 next to the handle 14. A coating 20 is placed over the strip 18 in order to cover it and, preferably, match the aftermarket touch sensor 12 to the color and/or appearance of the door 16.

The strip 18 preferably forms a capacitive sensor 12. As is known in the art, the strip 18 may be a conductive material such as copper and connected to capacitive touch sensor circuitry 22 which is contained on a PC board and detects the difference in the capacitance of the strip 18 when it is being touched by a user versus that of the strip 18 alone. The strip 18 preferably extends between the door handle 14 and the door's outer edge as illustrated, but may also be provided along the inside of the handle 14 if such an arrangement is feasible given the specific size and shape of the handle 14. It will be appreciated that the sensor strip 18 may not be limited to an elongate shape, but could similarly be provided in another shape.

Alternatively, the strip 18 could form a resistive sensor 12 and be connected to resistive touch sensor circuitry 22 which detects the difference in the resistance of the strip 18 when it is touched.

The coating 20 is preferably colored to match the door 16. An isolating element, such as a dielectric strip, is also provided beneath the sensor strip 18 for electrically isolating it from the door 16. It will be appreciated that this is important when the exterior of the door 16 is conductive and might interfere with the operation of the sensor 12.

In an alternative embodiment, the sensor strip 18 is a piezoelectric sensor wherein a change in pressure, i.e. contact from a user, results in a change in voltage which is detectable by the circuitry 22. In yet another alternative embodiment, the strip 18 includes a normally open circuit which is closed by contact from a user. As will be appreciated by a person skilled in the art, various other types of sensor strip 18 could be used and are within the scope of the present invention.

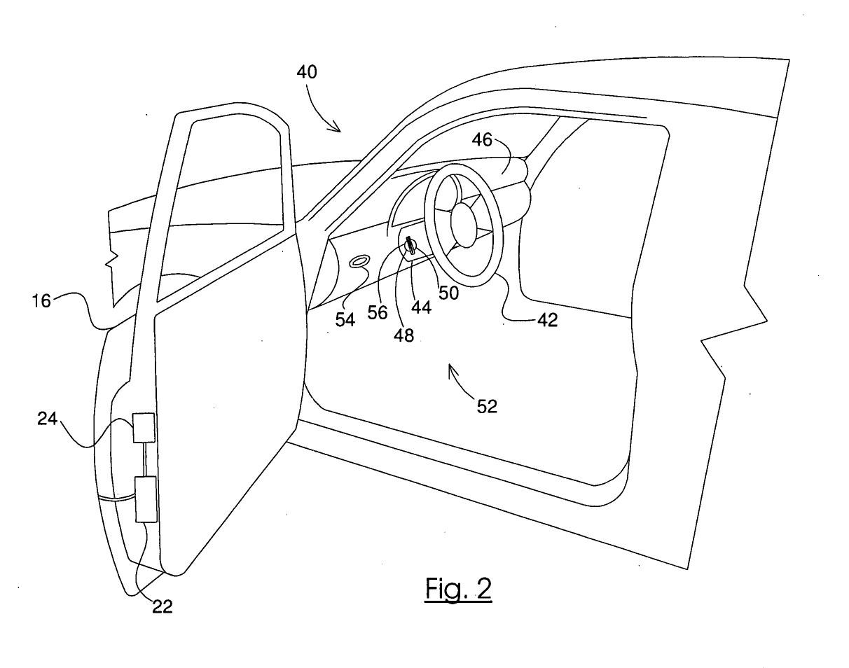

The touch sensor circuitry 22 is operatively connected to a transmitter 24 which communicates via a connection 26 with a control system 28. The circuitry 22 and transmitter 24 are preferably mounted along an inner portion of the vehicle door 16, as seen in FIG. 2, while the control system 28 may be deeper within the vehicle. The connection 26 between the transmitter 24 and the control system 28 may be either wireless or hard wired.

Upon detecting contact by a user, the touch sensor 12 transmits a “sensor contact” signal to the control system 28. Upon receipt of the “sensor contact” signal, the control system 28 is operable to use a reader 30 to transmit an RF signal in an attempt to detect a portable transponder 32. The transponder 32 is embedded in an object such as a key fob or card which is borne by the user. If the user is in possession of the required transponder 32, it will produce a corresponding reply to the RF signal and thereby identify the user as an authorized user. The control system 28 further includes a microcontroller or equivalent component which is operable to authenticate the reply.

The control system 28 is also operatively connected to the vehicle's security system. The security system is responsive to a disable command and upon authorization of the user the control system 28 is operable to transmit the disable command thereto. The disable command serves to effect a change in the state of the security system, usually in order to grant someone use of the vehicle. Preferably, this disable command serves to unlock the locks 34 and allow entry of the vehicle by the authorized user. The disable command may similarly include the disabling of unauthorized entry alarms and the like. If the transponder 32 is not detected, then the locks 34 will remain locked and no action will be taken by the user detection system 10.

Preferably, the control system 28 is operatively connected to one or more accessories 36 which may be customized to return to specific pre-determined settings upon recognition of the authorized user. These accessories 36 are responsive to one or more accessory control commands and may include, for example, actuators in and around the driver's seat and mirrors which adjust the seat, steering wheel, rearview mirror and side mirrors to the user's body, or a radio and/or entertainment system which control radio or media player preferences. The control system is also able to transmit the accessory control command(s) to the accessories 36 upon authentication of the reply.

The control system 28 may further be operatively connected to an engine starter 38 which can automatically start the vehicle's engine. The engine starter 38 is responsive to an engine start command and the control system 28 is able to transmit the engine start command to the engine starter 38 upon authentication of the reply.

A plurality of transponders 32 may be provided to identify several different authorized users. In this case, the control system 28 stores different accessory settings for each authorized user.

Preferably, the control system 28 is operable to recognize a plurality of sensor contact signals wherein a user is able to vary their contact with the touch sensor 12 according to what actions they want taken by the control system 28. For example, the control system 28 may unlock the door 16 in response to a single contact and both unlock the door 16 and start the engine in response to two distinct periods of contact. Alternatively, a user may vary the length of contact wherein a single touch unlocks the door 16 while a continued contact also then starts the engine.

In the above-noted case of multiple authorized users, the engine control system 38 is operable to engage certain engine limiting apparatuses. For example, a parent may program the user detection system 10 to impose a speed limit upon recognizing their child as an authorized user.

In another embodiment, the transponder 32 and reader 30 may be replaced by a biometric identification system such as a fingerprint sensor provided on the door 16. For even greater security, a fingerprint sensor may be provided in addition to the transponder 32 and reader 30. In yet another embodiment, a knock sensor may be employed which detects the vibration caused by a user knocking the vehicle's window.

It will be appreciated that the user detection system advantageously permits the installation of an aftermarket keyless entry system, without requiring the installation of a conventional OEM-type touch sensor. Such a system can be installed by providing the transponder 32, fixing an isolating strip to the exterior of the vehicle such that a user can contact the strip while approaching and/or grasping the handle 14, fixing the sensor strip 18 to the isolating strip and covering the sensor strip 18 with the coating 20 in order to protect and mask it presence. The sensor circuitry 22 and transmitter 24 are mounted along the inside of the door 16 in a position which is easily accessible to the installer but not accessible when the door 16 is closed. The touch sensor 12 is then connected to sensor circuitry 22 and the control system 28 is provided.

With reference again to FIG. 2, the driver compartment 40 of the vehicle includes a steering wheel 42 mounted on a steering column 44 which is itself mounted to a dashboard 46. As is known in the art, an ignition lock 48 is located on the steering column 44, however, it will be appreciated that the lock 48 may appear elsewhere within the driver compartment 40. A key 50, which is operable unlock the steering wheel 42 and column 44 and start the vehicle, is inserted into the ignition lock 48.

While it is not uncommon for a vehicle owner to replace and/or otherwise customize the steering wheel 42, the steering column 44 and ignition lock 48 are typically stock, OEM components.

As part of an aftermarket push-to-start system 52, a push-button 54 is installed on the dashboard 46 although it will be appreciated that it too may appear elsewhere within the driver compartment 40. The push-button 54 may alternatively be hidden or otherwise concealed within the compartment 40. The push button 54 is operatively connected to the engine control starter 38 shown on FIG. 1 via a controller. In use, a user is operable to start the engine by engaging the button 54 which triggers the controller to transmit the engine start command to the engine starter 38.

As discussed above, many vehicles include a steering column locking mechanism which locks the steering column 44 and the steering wheel 42 unless the vehicle's ignition key 50 is received within the ignition lock 48. Alternatively, the steering column lock is electronically actuated and responsive to a steering column lock disable command.

In order to overcome this requirement, a disabling means is used. The locking mechanism may be permanently disabled or, given an electronic control of the ignition lock 48, the databus code which unlocks the steering column 44 may be copied and sent by a controller within the aftermarket push-to-start system 52. Such a databus code or electrical signal may be used to unlock the steering column 44 in response to the user pushing a button on an aftermarket remote control. Alternatively, the OEM key 50 may be permanently installed within the ignition lock 48 and a manual actuator 56, such as a knob or handle, is attached to the OEM key 50 and/or the ignition lock 48, for example to its housing, so as to enclose the OEM key 50 in the key barrel.

In use, the user will enter the driver compartment 40, turn the knob 56 so as to unlock the steering column 44 and push the push-button 54 and thereby start the vehicle's engine.

The push-to-start system 52 is preferably used in conjunction with a transponder-based keyless entry system such as the user detection system 10. Generally, such a system including a user borne transponder 32 for user authorization is preferably required to enable starting of the engine in response to the pushing of the button 54. Specifically in the case of the user detection system 10, the control system 28 is further operatively connected to the vehicle ignition system and able to send it an “engine start enable” signal. Without receiving such and enabling signal, the vehicle ignition system will not start the vehicle.

If the vehicle already has an OEM security system including an OEM transponder, for example housed within the OEM key 50, that transponder is removed or otherwise deactivated prior to being fixed within the lock 48. The OEM key 50 can be cut so as to remove the key head containing the OEM transponder and retain only the portion necessary for insertion into the barrel and unlocking of the steering column. The OEM transponder may then be secured somewhere on or in the vehicle such that communication between the OEM transponder and the OEM security system may be controlled by the aftermarket push-to-start system 52.

By the push-to-start system 52 with an aftermarket transponder-based user authentication system, an unauthorized user (i.e. one not in possession of the necessary aftermarket transponder) who enters the vehicle will be able to unlock the steering column by turning the knob 56 but will not be able to start the engine.

Of course, numerous modifications could be made to the above-described embodiments without departing from the scope of the invention, as apparent to a person skilled in the art.

What is claimed is:

1. A user detection system for a vehicle having a security system, an exterior surface and a handle installed into the exterior surface, the security system being responsive to a disable command, the user detection system comprising:
a) a portable transponder for verification of user;
b) a touch sensor for detecting contact made by the user and transmitting a sensor contact signal in response thereto, the touch sensor comprising:
i) a sensor strip installed on the exterior surface proximate the handle; and
ii) a coating for covering the sensor strip, the coating visibly matching the exterior surface;
c) a control system in communication with the touch sensor and the security system, the control system comprising:
i) a reader for transmitting an identification signal to the portable transponder and receiving a corresponding reply; and
ii) a microcontroller for authenticating the reply;
wherein the control system is operable to transmit the identification signal in response to receiving the sensor contact signal; and
wherein the control system is operable to transmit the disable command to the security system upon authentication of the reply.

2. The user detection system of claim 1, further comprising an isolating strip between the exterior body and the sensor strip.

3. The user detection system of claim 1, wherein the microcontroller is mounted inside the vehicle and the control system further comprises sensor circuitry connected to the touch sensor, the sensor circuitry being operable to wirelessly communicate with the microcontroller.

4. The user detection system of claim 3, wherein the vehicle comprises a door and the sensor circuitry is installed along an inner portion of the vehicle door.

5. The user detection system of claim 1, wherein the security system comprises a door lock and the disable command is operable to disable the door lock.

6. The user detection system of claim 5, wherein the vehicle comprises an accessory, the accessory being responsive to an accessory control command, and the control system is operable to transmit the accessory control command to the accessory upon authentication of the reply.

7. The user detection system of claim 5, wherein the vehicle comprises an engine starter, the engine starter being responsive to an engine start command, and the control system is operable to transmit the engine start command to the engine starter upon authentication of the reply.

8. The user detection system of claim 1, wherein the control system is operable recognise a plurality of different sensor contact signals and transmit a corresponding plurality different commands upon authentication of the reply.

9. The user detection system of claim 1, wherein the sensor strip is a capacitive sensor.

10. The user detection system of claim 1, wherein the sensor strip is a piezoelectric sensor.

11. A method of installing a user detection device for a vehicle comprising a security system, an exterior surface and a handle installed into the exterior surface, the security system being responsive to a disable command, the method comprising:
a) providing portable transponder for user verification;
b) fixing a sensor strip to the exterior surface proximate the handle;
c) covering the sensor strip with a coating, the sensor strip being operable to detect contact between the user and the coating and operable to transmit a sensor contact signal in response thereto;
d) providing a control system in communication with the sensor strip and the security system, the control system comprising:
i) a reader for transmitting an identification signal to the transponder and receiving a corresponding reply; and
ii) a microcontroller for authenticating the reply;
wherein the control system is operable to transmit the identification signal in response to receiving the sensor contact signal; and
wherein the control system is operable to transmit the disable command to the security system upon authentication of the reply.

12. An aftermarket push-to-start system for a vehicle including a driver compartment, a steering column lock responsive to a steering column lock disable command and an engine starter responsive to an engine start command, the system comprising:
a) a push-button installed within the driver compartment;
b) a controller operable to transmit the engine start command to the engine starter in response to engagement of the push-button by a user;
c) steering column lock disabling means operable to transmit the steering column lock disable command to the ignition lock in response to engagement of the push-button by the user; and
d) driver identification means for authenticating a user.

13. The aftermarket push-to-start system of claim 12, wherein the driver identification means comprises:
a) a portable transponder;
b) a reader operable to transmit an identification signal to the transponder in response to engagement of the push-button by a user and receiving a reply;
c) a microcontroller for authenticating the reply;
wherein the controller is operable to transmit the engine start command upon authentication of the reply by the microcontroller.

14. An aftermarket push-to-start system for a vehicle including a driver compartment, an ignition key, an ignition lock operable to receive the ignition key and an engine starter responsive to an engine start command, the system comprising:
a) a push-button installed within the driver compartment;
b) a controller operable to transmit the engine start command to the engine starter in response to engagement of the push-button by a user;
c) manual actuator fixed to the ignition lock and operable to retain the ignition key therein; and
d) driver identification means for authenticating a user.

15. The aftermarket push-to-start system of claim 14, wherein the driver identification means comprises:
a) a portable transponder;
b) a reader operable to transmit an identification signal to the transponder in response to engagement of the push-button by a user and receiving a reply;
c) a microcontroller for authenticating the reply;
wherein the controller is operable to transmit the engine start command upon authentication of the reply by the microcontroller.
